(19) United States
(12) Patent Application Publication
(10) Pub. No.: US 2006/0198335 A1
(43) Pub. Date: Sep. 7, 2006

(54) Embedding secondary transmissions in an existing wireless communications network

(76) Inventors: Jukka Reunamaki, Tampere (FI); Juha Salokannel, Kangasala (FI)

Correspondence Address: MORGAN & FINNEGAN, LLP, 3 World Financial Center, New York, NY, 10281-2101, US

(21) Appl. No.: 11/071,677

(22) Filed: Mar. 4, 2005

(51) Int. Cl. H04J 3/16; H04J 3/22; H04Q 7/00

(52) U.S. Cl. 370/328; 370/468; 370/466

(57) ABSTRACT

A first device participates in a wireless communications network having a transmission medium designated for exchanging wireless signals in a first format that is associated with the wireless communications network. A portion of the transmission medium is reserved for the transmission of signals in a second format, which may be incompatible with the first format. Accordingly, one or more signals of the second format are transmitted to a remote wireless communications device. These one or more signals of the second format facilitate the remote wireless communications device's participation in the wireless communications network. Accordingly, the remote wireless communications device may be awakened from a sleep state or a hibernation state.

### FIELD OF THE INVENTION

The present invention relates to wireless communications. More particularly, the present invention relates to techniques that utilize the bandwidth of existing networks for alternative transmissions.

### BACKGROUND OF THE INVENTION

Short-range wireless proximity networks typically involve devices that have a communications range of one hundred meters or less. To provide communications over long distances, these proximity networks often interface with other networks. For example, short-range networks may interface with cellular networks, wireline telecommunications networks, and the Internet.

A high rate physical layer (PHY) standard is currently being selected for IEEE 802.15.3a. The existing IEEE 802.15.3 media access control layer (MAC) is supposed to be used as much as possible with the selected PHY. Currently, there are two remaining PHY candidates. One of these candidates is based on frequency hopping application of orthogonal frequency division multiplexing (OFDM). The other candidate is based on M-ary Binary offset Keying. The OFDM proposal is called Multiband OFDM (MBO). Moreover, in order to further develop the OFDM proposal outside of the IEEE, a new alliance has been formed called the MultiBand OFDM Alliance (MBOA).

MBO utilizes OFDM modulation and frequency hopping. MBO frequency hopping may involve the transmission of each of the OFDM symbols at various frequencies according to pre-defined codes, such as Time Frequency Codes (TFCs). Time Frequency Codes can be used to spread interleaved information bits across a larger frequency band.

Presently, there is an interest within the MBOA to create a Medium Access Control (MAC) layer that would be used with the OFDM physical layer instead of the IEEE 802.15.3 MAC layer. A current version of the MBOA MAC involves a group of wireless communications devices (referred to as a beaconing group) that are capable of communicating with each other. The timing of beaconing groups is based on a repeating pattern of “superframes” in which the devices may be allocated communications resources.

MAC layers govern the exchange among devices of transmissions called frames. A MAC frame may have various portions. Examples of such portions include frame headers and frame bodies. A frame body includes a payload containing data associated with higher protocol layers, such as user applications. Examples of such user applications include web browsers, e-mail applications, messaging applications, and the like.

In addition, MAC layers govern the allocation of resources. For instance, each device requires an allocated portion of the available communication bandwidth to transmit frames. The current MBOA MAC proposal provides for the allocation of resources to be performed through communications referred to as beacons. Beacons are transmissions that devices use to convey non-payload information. Each device in a beaconing group is assigned a portion of bandwidth to transmit beacons.

Such transmissions allow the MBOA MAC to operate according to a distributed control approach, in which multiple devices share MAC layer responsibilities. Accordingly, the current MBOA MAC Specification (version 0.93, January 2005) provides various channel access mechanisms that allow devices to allocate portions of the transmission medium for communications traffic. These mechanisms include a protocol called the distributed reservation protocol (DRP), and a protocol called prioritized contention access (PCA).

MBOA provides active, hibernating, and sleep modes of device operation. A device operating in the active mode belongs to a beaconing group and transmits a beacon during every superframe. A device operating in the hibernating mode also belongs to a beaconing group. However, when operating in this mode, the hibernating device does not transmit a beacon during each superframe. Instead, the hibernating device transmits beacons at a lesser rate (e.g., every six superframes). In contrast, a device operating in the sleep mode does not belong to a beaconing group. Therfore, a device operating in this mode does not transmit beacons.

When two or more MBOA devices want to communicate, they must be in either an active or a hibernating mode. In the active mode, a device can commence communications with minimal delay. However, power consumption is the highest in the active mode. On the other hand, a device can reduce its power consumption to a certain degree when it is in the hibernating mode. However, the power consumption of a hibernating device can still be too high when the device is powered by batteries.

Therefore, it is desirable for an MBOA device that is not actively participating in network communications to be in the sleep mode. When in this mode, the device does not need to send beacons within a certain time interval. Accordingly, sleep mode operation requires minimal power consumption. Unfortunately, waking a device up from sleep mode to initiate communications is problematic. This is because general MBOA communications can not be used to wake up a sleeping device.

### SUMMARY OF THE INVENTION

The present invention provides a method and apparatus. According to aspects of the present invention, the method and apparatus participate in a wireless communications network having a transmission medium designated for exchanging wireless signals in a first format associated with the wireless communications network. A portion of the transmission medium is reserved for the transmission of signals in a second format, which may be incompatible with the first format. Accordingly, one or more signals of the second format are transmitted to a remote wireless communications device. These one or more signals of the second format facilitate the remote wireless communications device's participation in the wireless communications network.

The transmission medium includes a repeating time interval, such as a superframe provided by an MBOA network. Thus the reserved portion of the transmission medium may include one or more time slots (such as one or more MBOA media access slots) within the repeating time interval.

The one or more signals of the second format may include a wake up signal. Accordingly, the remote device may be in a hibernating mode or a sleep mode. This wake up signal may be in the form of a radio frequency identification (RFID) signal and/or a predetermined sequence of OFDM symbols. The wake up signal may include information, such as an address of the remote device and/or configuration information regarding the wireless communications network.

The present invention also provides a computer program product for enabling a processor in a computer system to control a wireless communications device in the performance of the above features.

Moreover, the present invention provides a method that receives one or more signals from a remote wireless communications device. The remote device participates in a wireless communications network having a transmission medium designated for exchanging wireless signals in a first format associated with the wireless communications network. However, the one or more signals received from the remote device are within a portion of the transmission medium and in a second format, but incompatible with the wireless communications network. In response to the one or more signals received from the remote wireless communications device, the method actively participates in the wireless communications network. The present invention also provides an apparatus that may operate according to this method and a computer program product that facilitates device operation according to this method.

Further features and advantages of the present invention will become apparent from the following description, claims, and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary operational environment;

FIG. 2 is a diagram showing an exemplary MBOA superframe format;

FIG. 3 is a diagram of an exemplary MBOA reservations;

FIGS. 4 and 5 are diagrams of exemplary contention-based MBOA allocation processes;

FIG. 6 is a flowchart of a device operation, according to an embodiment of the present invention;

FIG. 7 is a diagram of an RFID system;

FIGS. 8-11 are block diagrams of exemplary wireless communications devices, according to embodiments of the present invention; and

FIG. 12 is a diagram of an exemplary wireless communications device implementation, according to an embodiment of the present invention;

### DETAILED DESCRIPTION OF THE PREFERRED EMBODIMENTS

I. Operational Environment

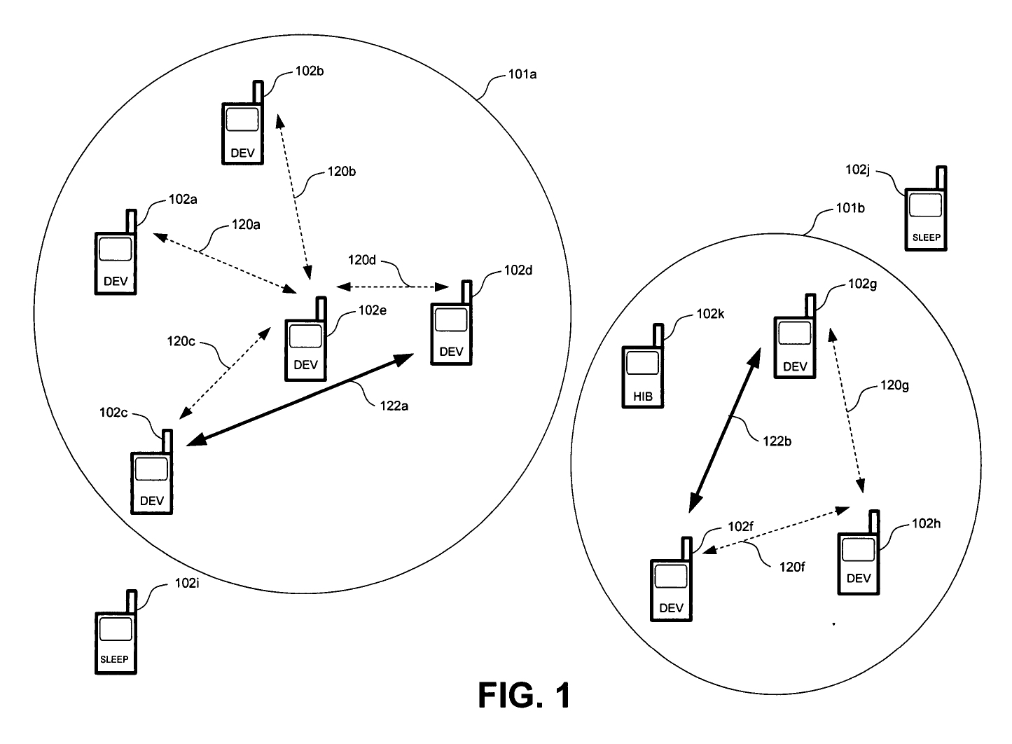

Before describing the invention in detail, it is first helpful to describe an environment in which the present invention may be employed. Accordingly, FIG. 1 is a diagram of an exemplary operational environment. This environment includes multiple beaconing groups 101, each having a plurality of devices 102. For instance, FIG. 1 shows a beaconing group 101a, which includes member devices (DEVs) 102a-e. FIG. 1 also shows a beaconing group 101b, which includes DEVs 102f, 102g, 102h, and 102k (device 102k is operating in a hibernating mode).

In beaconing group 101a, each of DEVs 102a-d may communicate with DEV 102e across a corresponding link 120. For instance, FIG. 1 shows DEV 102a communicating with DEV 102e across a link 120a. In addition, in beaconing group 101a, each of devices 102a-e may communicate with each other directly. For instance, FIG. 1 shows DEVs 102c and 102d communicating via a direct link 122a.

In beaconing group 101b, each of DEVs 102f and 102g may communicate with DEV 102h across a corresponding link 120. For instance, DEV 102f communicates with DEV 102h across a link 120f, while DEV 102g communicates with DEV 102h across a link 120g. DEVs 102f and 102g in beaconing group 101b may also communicate with each other. For example, FIG. 1 shows DEVs 102f and 102g communicating across a link 122b.

Each of links 122 and 120 may employ various frequency hopping patterns. These patterns may include, for example, one or more Time Frequency Codes (TFCs). In embodiments of the present invention, each beaconing group 101 employs a particular frequency hopping pattern. These patterns may either be the same or different.

In addition, FIG. 1 also shows devices 102i and 102j, which are operating in a sleep mode. However, according to embodiments of the present invention, devices within beaconing groups 101a and 101b may activate these devices through non-MBOA transmissions.

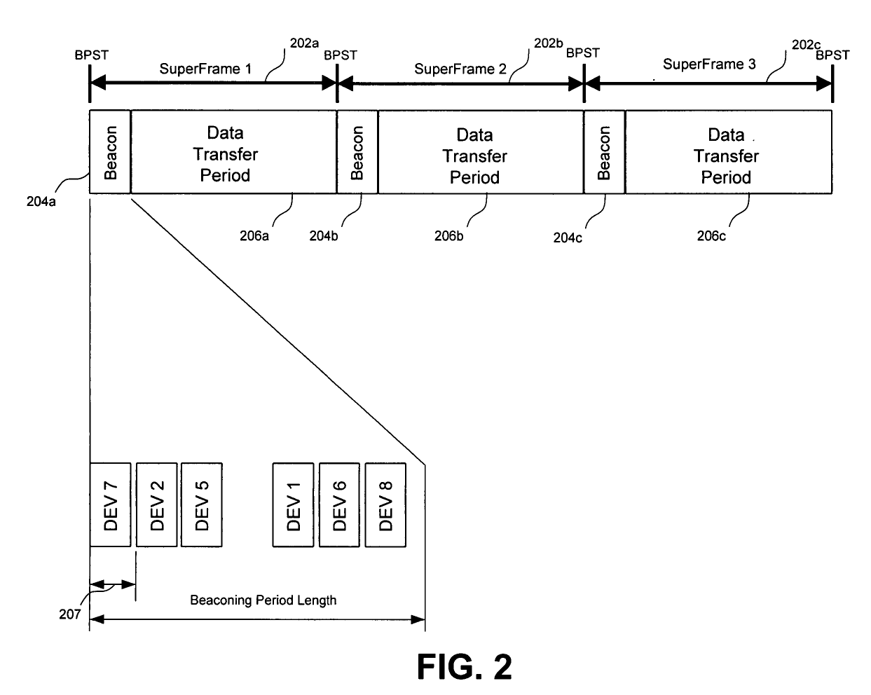

Transmissions of beaconing groups 101a and 101b are each based on a repeating pattern called a superframe. Accordingly, FIG. 2 is a diagram showing an exemplary MBOA superframe format. In particular, FIG. 2 shows a frame format having superframes 202a, 202b, and 202c. As shown in FIG. 2, superframe 202b immediately follows superframe 202a, and superframe 202c immediately follows superframe 202b.

Each superframe 202 includes a beacon period 204 and a data transfer period 206. Beacon periods 204 convey transmissions from each of the active devices in the beaconing group. Accordingly, each beacon period 204 includes multiple beacon slots 207. Slots 207 each correspond to a particular device in the beaconing group. During these slots, the corresponding device may transmit various overhead or networking information.

For instance, such information may be used to set resource allocations and to communicate management information for the beaconing group. In addition, according to the present invention, data transfer periods 206 may be used to transmit information regarding services and features (e.g., information services, applications, games, topologies, rates, security features, etc.) of devices within the beaconing group. The transmission of such information in beacon periods 204 may be in response to requests from devices, such as scanning devices.

Data transfer period 206 is used for devices to communicate data according to, for example, frequency hopping techniques that employ OFDM and/or TFCs. For instance, data transfer periods 206 may support data communications across links 120 and 122. In addition, devices (e.g., DEVs 102a-e) may use data transfer periods 206 to transmit control information, such as request messages to other devices. To facilitate the transmission of traffic, each DEV may be assigned a particular time slot within each data transfer period 206. In the context of the MBOA MAC specification, these time slots are referred to as media access slots (MASs).

A MAS is a period of time within data transfer period 206 in which two or more devices are protected from contention access by devices acknowledging the reservation. MASs may be allocated by a distributed protocol, such as the distributed reservation protocol (DRP). Alternatively, resources may be allocated by the prioritized contention access (PCA) protocol. Unlike DRP, PCA isn't constrained to reserving one or more entire MASs. Instead, PCA can be used to allocate any part of the superframe that is not reserved for beaconing or DRP reservations.

II. Media Access

As described above, MBOA channel time is divided into superframes. Each superframe includes a beacon period (BP) and a data transfer period. During the data transfer period, devices may send and receive data using various media access techniques. For instance, MBOA currently provides a prioritized contention access (PCA) technique and a distributed reservation protocol (DRP) access technique.

For DRP access, a negotiation of channel time (e.g., MASs) is carried out among peer devices. This negotiation takes into account the existing set of reservations among DEVs. Reservations are indicated in beacons using information elements called DRP IEs and Availability IEs. An Availability IE comprises a bitmap that indicates for each MAS whether or not a device can accept DRP reservations or PCA traffic.

Availability IEs may also indicate whether a device can accept PCA traffic. PCA is a prioritized access mechanism used by MBOA devices that employ carrier sense multiple access with collision avoidance (CSMA/CA).

Media access according to PCA is preceded by a specific listening period (called Inter Frame Spacing (IFS)) and a request-to-send/clear-to-send (RTS/CTS) procedure. In particular, a device (referred to herein as an initiating device) desiring to establish channel access with another device (referred to herein as a target device) determines whether the transmission medium is idle for the specific listening period. This is done through the use of the carrier sensing. If so, then the initiating device transmits an RTS frame that specifies the target device. In response to the RTS frame, the target device transmits a CTS frame after a predetermined time interval if it senses that the transmission medium is idle. However, if the target device does not sense that the transmission frame is idle, it refrains from transmitting a CTS frame.

After transmitting the RTS frame, the initiating device waits for an indication that it may transmit. If such an indication fails to occur during a predetermined time interval, the initiating device concludes that transmission of the RTS has failed. After reaching this conclusion, the initiating device invokes a backoff procedure in which the allocation may be attempted again after a time delay.

Conversely, if the initiating device receives an indication that it may transmit during this predetermined time interval, the initiating device may commence the transfer of frames with the target device. This exchange of frames may occur for an interval of time referred to as a transmission opportunity (TXOP). During the TXOP, the initiating device maintains uninterrupted control of the transmission medium.

III. Secondary Transmissions

As described above, the present invention allows the resource allocation techniques of an already existing wireless communications network to allocate resources for other wireless communications. In aspects of the present invention, these other wireless communications (referred to herein as secondary transmissions) do not interfere with transmissions of the already existing wireless communications network (referred to herein as primary transmissions).

The already existing wireless communications network may include one or more MBOA beaconing groups. Thus, in such embodiments, one or more MBOA media access techniques (e.g., DRP and PCA) may be employed to allocate portions of the transmission medium's capacity for non-MBOA transmissions. Examples of such non-MBOA transmissions include Bluetooth, RFID, and WLAN transmissions.

Moreover, such non-MBOA transmissions may include all kinds of communications that can be exchanged between a device belonging to the beaconing group and another device that does not actively participate (or belong to) the beaconing group. Such devices may include a hibernating, sleeping, and/or non-connected device that needs to be joined to (or actively participate with) the beaconing group.

In embodiments involving an existing MBOA network, allocations for non-MBOA transmissions may be established with DRP. In such aspects, DRP may be used to coordinate non-MBOA transmissions between two devices having MBOA capabilities or between two devices in which only one device has MBOA capabilities.

When DRP is employed to allocate non-MBOA transmission capacity between two MBOA capable devices, a channel time reservation is negotiated. This negotiation may be done implicitly in beacons. Alternatively, this negotiation may be performed explicitly by using PCA or communications during channel time that is allocated by existing DRP reservations.

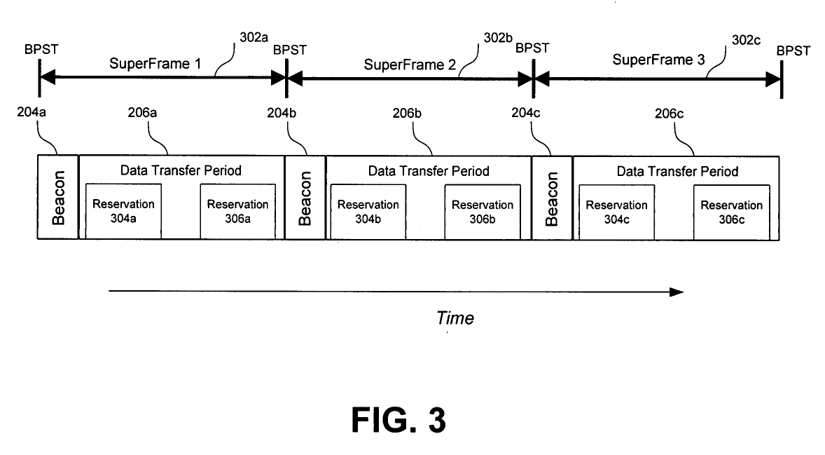

FIG. 3 is a diagram of MBOA superframes 302 having channel time reservations 304 and 306. Reservation 304 is allocated to two MBOA capable devices for non-MBOA transmissions. In contrast, reservation 306 is allocated for MBOA transmissions. As shown in FIG. 3, each of reservations 304 and 306 has a corresponding time period (e.g., one or more MASs). For instance, reservation 304 includes time period 304a, 304b, and 304c, while reservation 306 includes time periods 306a, 306b, and 306c.

Reservation 304 is a hard or private type reservation (with highest priority). This prevents other devices from taking reservation 304 or using its corresponding time period (e.g., one or more MASs) within superframes 302 for other purposes. Accordingly, the devices associated with reservation 304 may use the corresponding time period for non-MBOA transmissions. The reservation is repeated in beacons during every superframe for as long as desired to be valid.

As stated above, DRP may be employed to establish a reservation for non-MBOA transmissions between two devices in which only one of them has MBOA capabilities. To perform such an allocation, the MBOA capable device (acting as the initiating device) needs to make the other MBOA devices in the beaconing group perceive that a DRP-based channel reservation has been established. This is because the target device (which does not have MBOA capabilities) does not transmit MBOA transmissions (e.g., beacons) in accordance with this establishment.

To establish this perception, the MBOA capable device transmits a DRP IE in its beacon transmissions. As with normal reservations, each of these beacons sets its status bit flag. As provided by MBOA, this flag indicates whether a reservation is under negotiation or valid. According to embodiments of the present invention, the MBOA capable device sets the status bit within the same superframe that it begins using the medium for non-MBOA transmissions. Because of this, the other MBOA devices in the beaconing group will honor the reservation signified by the flag.

As stated above, allocations for non-MBOA transmissions may also be made through the employment of PCA. The PCA resource allocation process is preceded by a specific listening period (IFS) and a RTS/CTS procedure. When two MBOA interoperable devices use PCA, the initiating device will transmit some preparing information in its beacon to notify the target device.

Then, at a suitable moment during the data transfer period of the MBOA superframe, the initiating device will start the communication by waiting for a successful AIFS period and sending an RTS message.

After transmission of the RTS message, the target device will then respond with a corresponding CTS message. If this exchange of messages has succeeded, the device will “own” the medium during the time period that was indicated in the RTS and CTS messages. Accordingly, the devices may send MBOA data or any other radio transmissions during this time period.

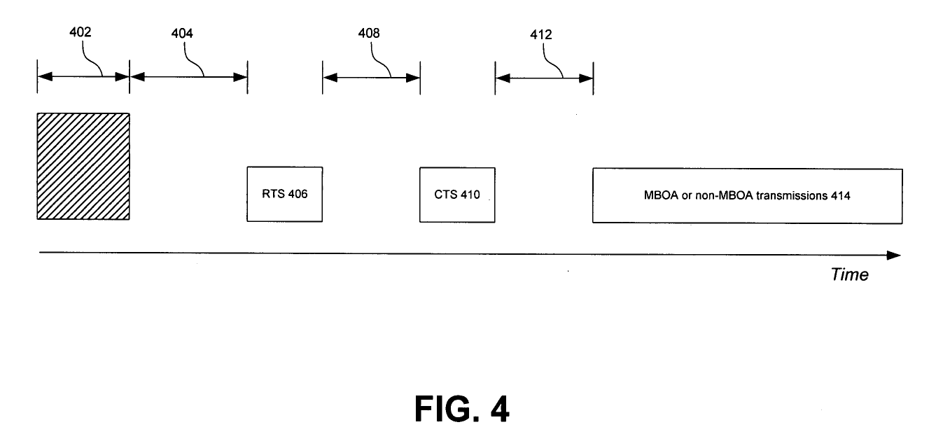

FIG. 4 is a diagram illustrating such a process involving two MBOA capable initiating devices. As shown in FIG. 4, the initiating device waits for a predetermined time interval 404 immediately following a channel busy condition 402. After this predetermined time interval, the initiating device transmits RTS 406. Following a delay period 408, the target device responds with a CTS message 410. Next, after waiting a time interval 412, the initiating device transmits MBOA or non-MBOA transmissions 414.

Additionally, PCA may be employed to allocate resources for non-MBOA transmissions between two devices in which only one of the devices has MBOA capabilities. To perform such an allocation, the MBOA capable device may on its own reserve a time period within the MBOA transmission medium by PCA. This reserved time period is then used to exchange secondary (i.e., non-MBOA) transmissions with the other device(s).

To reserve this time period, the MBOA capable device may send an RTS and a CTS itself, similar to the technique shown in FIG. 4. Alternatively, the MBOA capable device may send only an RTS. An advantage of this approach is that it is more efficient than the MBOA capable device transmitting both an RTS and a CTS. However, devices that are unable to receive the RTS or CTS because they are beyond the initiating device's communicating range will not appreciate and make the corresponding channel reservation—even though they may be capable of receiving transmissions from the target device.

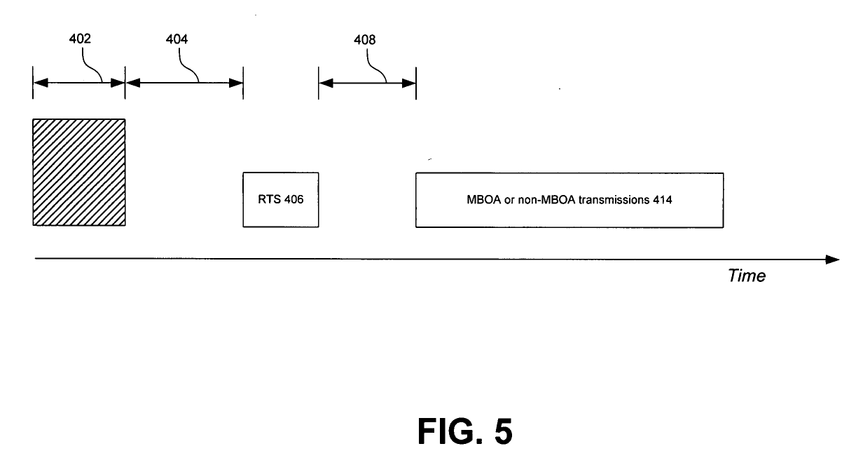

FIG. 5 is a diagram illustrating this RTS only approach. The duration of the channel reservation is included in the RTS message. According to PCA, other MBOA devices in the beaconing group understand from this RTS message that they should not disturb transmissions that occur during the time period specified by the RTS message. These other MBOA devices do not realize that this time period has been allocated for non-MBOA transmissions. Thus, bypassing the transmission of a CTS message does not reduce the effectiveness of this resource allocation.

IV. Wake-Up Signaling

In embodiments of the present invention, resource allocation techniques, such as the ones described above, may be used to perform wake-up signaling. Such signaling activates other devices, such ones having RFID tag functionality. Devices having such RFID tag functionality may be referred to as being equipped with “RFID activator tags.”

For example, an initiating device with MBOA capabilities may reserve a portion of the transmission medium for RFID signaling (i.e., non-MBOA transmissions). This may be performed through one of the various techniques described above. During this reserved portion, the non-MBOA radio transmission period, the initiating MBOA device may act as RFID reader and can communicate with another device using RFID. The RFID signaling may be a wake-up command to the second device to start synchronization with the MBOA beaconing period in order to join the beacon group. According to other embodiments, also other short-range radio communication techniques may be used instead of RFID.

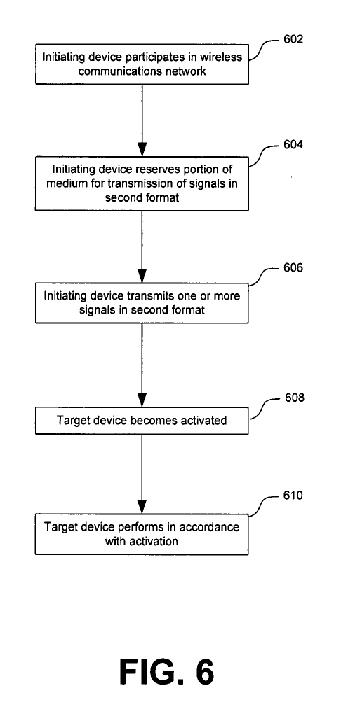

FIG. 6 is a flowchart illustrating an operation of wake-up signaling according to embodiments of the present invention. This operation is described in the context of MBOA and RFID transmissions. However, other types of transmissions may be employed.

In a step 602, an initiating device participates in a wireless communications network having a transmission medium designated for exchanging wireless signals in a first format. For instance, the wireless communications network may be an MBOA network (e.g., one or more beaconing groups) associated with the wireless communications network in an MBOA beaconing group.

In a step 604, the initiating device reserves a portion of the transmission medium for the transmission of signals in a second format. For example, this step may comprise the initiating device allocating a portion of the MBOA transmission medium for the exchange of non-MBOA transmissions with a target device. This step may comprise employing the DRP or PCA techniques described above.

In embodiments, the target device may not have MBOA capabilities. This lack of MBOA capabilities may be a permanent condition or a condition that exists only until the target device is activated. Therefore, step 604 may comprise employing the DRP or PCA techniques described above involving only one device having MBOA capabilities.

In a step 606, the initiating device transmits one or more signals of the second format to a remote wireless communications device. For example, these signals may be non-MBOA transmissions within the portion of the transmission medium allocated in step 604. These signals of the second format may facilitate the target device's participation in the wireless communications network. For example, these signals may cause activation of the target device in hibernating or sleep states. Alternatively, these signals of the second format may cause the target device in other states to join the wireless communications network.

Accordingly, in embodiments, such transmission(s) include an RFID wake-up signal transmitted by the initiating device. Additionally, step 606 may further include the exchange of signals in the second format. For instance, the target device may respond to the RFID wake-up signal with one or corresponding RFID response transmissions.

In embodiments, the signals of the second format may be OFDM signals. For instance, in step 606, the initiating device may transmit OFDM signals having a unique symbol sequence that is interpreted by the target device as a wake-up signal. In addition, the initiating device may transmit further information, such as the target device's MAC address to verify that the initiating device intends to wake-up the target device.

In addition, the initiating device may transmit further information. For instance, when the wake-up signal is used for the device to join the already existing network, the further information may be information that allows connection setup between the devices to be accelerated. Thus, examples of such information include the channel to be used for association, device class address, beacon period start time offset, beacon period occupancy information, other information regarding the neighboring devices, the initiating device's MAC address, security keys, authentication information, and the like.

Accordingly, in a step 608, the target device becomes activated based on the non-MBOA transmission from the initiating device in step 606. This activation may specify a particular course of performance by the target device. For example, the activation may specify joining the MBOA beaconing group.

As shown in FIG. 6, a step 610 follows step 608. In this step, the target device performs in a manner that is consistent with the activation. For example, in accordance with the example described in the preceding paragraph, the target device may join the MBOA beaconing group. This allows the target device to engage in MBOA communications with other devices in the group.

Although FIG. 6 shows steps being performed in a particular order, the above steps may be performed in other orders. Moreover, intermediate steps may be incorporated into these sequences.

V. RFID

As described above, the wake-up signaling example of FIG. 6 may involve RFID communications as secondary (i.e., non-MBOA) transmissions. Radio frequency identification (RFID) technology involves a reader that utilizes electromagnetic energy to wirelessly solicit information from one or more tags that are either touching the reader or are within a predetermined range of the reader. This soliciting of information is referred to herein as an interrogation. Through an interrogation, a reader may receive tag identifiers (e.g., tag ID numbers) as well as other additional information. Thus, a reader can perform interrogations to determine the presence and identity of one or more tags. Moreover, a reader can perform interrogations to initiate or activate a certain operation of tags.

In the wake-up signaling example of FIG. 6, the initiating device and the target device exchange non-MBOA transmissions in step 606. In aspects where these non-MBOA transmissions are RFID signals, the initiating device may act as an RFID reader and the target device may act as an RFID tag.

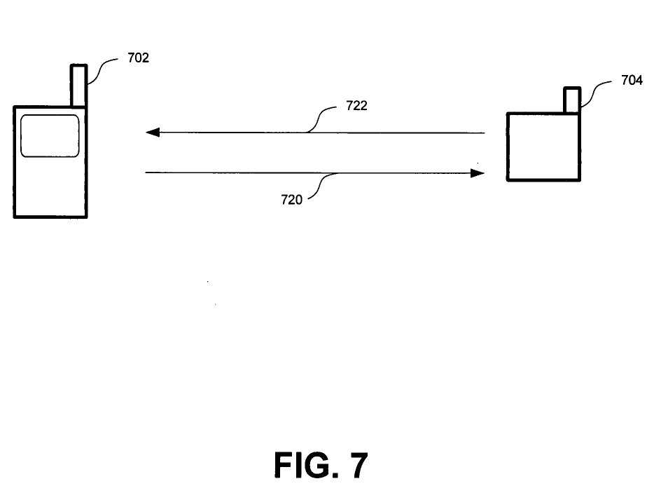

FIG. 7 is a diagram of an RFID system having an RFID reader 702, and an RFID tag 704. As shown in FIG. 7, RFID reader 702 generates and transmits an interrogation signal 720, which is received by tag 704. In response, tag 704 generates a corresponding reply signal 722 that is sent to reader 702. In the context of FIG. 6, these signals are exchanged in step 606.

Interrogation signal 720 may specify particular information. For instance, interrogation signal 720 may identify a particular tag (e.g., a target device). Also, in embodiments, interrogation signal 720 may specify a particular course of conduct or an operational mode for such a target device.

Reply signal 722 may include various information. For instance, reply signal 722 may include tag identification information (such as a tag ID number). In addition, reply signal 722 may include other information such as, for example, data specific to the tag's location or environment.

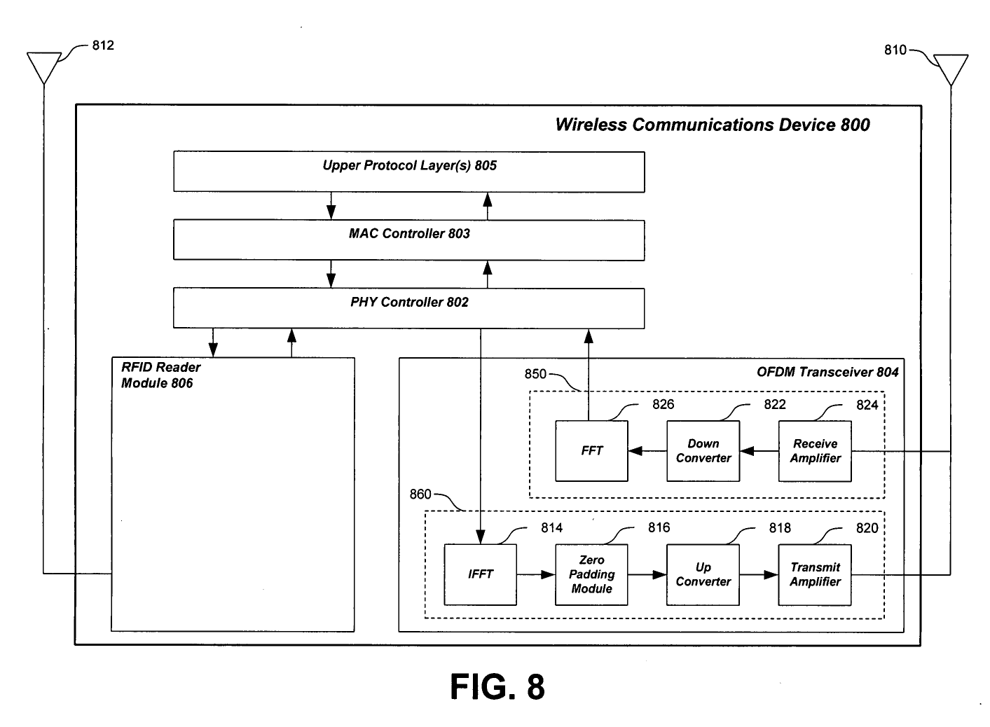

A reader may transmit interrogation signals in the form of clock pulses that provide receiving tags with a guide for communicating (i.e., for transmitting reply signals) back to the reader. These reply signals may involve backscatter reflections of the interrogation signals. Examples of such backscatter reflections are described in greater detail below with reference to FIGS. 8-10.

VI. Device Implementation

FIGS. 8-11 are diagrams of wireless communications devices, which may operate according to the techniques of the present invention. These devices may be used in various communications environments, such as the environment of FIG. 1.

FIG. 8 is a block diagram of a wireless communications device 800 with MBOA and RFID reader capabilities. As shown in FIG. 8, device 800 includes a physical layer (PHY) controller 802, a media access controller (MAC) 803, an OFDM transceiver 804, upper protocol layer(s) 805, and an RFID reader module 806. In addition, device 800 includes and antennas 810 and 812. In embodiments of the present invention, device 800 may be used as an initiating device to commence the allocation of resources for non-MBOA communications.

MAC controller 803 generates frames (data transmissions) and beacons for wireless transmission. In addition, MAC controller 803 receives and processes frames and beacon transmissions that are originated from remote devices. MAC controller 803 exchanges these frames and beacon transmissions with PHY controller 802. In turn, PHY controller 802 exchanges frames and beacon transmissions with OFDM transceiver 804. Further, MAC controller 803 may operate to reserve communications resources for the transmission of non-MBOA signals. For example, in embodiments, MAC controller 803 may perform steps of FIG. 6.

Accordingly, MAC controller 803 may initiate RFID communications through the generation of interrogation signals, which are sent (through PHY controller 802) to RFID reader module 806. Also, MAC controller may receive (through RFID reader module 806 and PHY controller 802) information conveyed in RFID response signals.

OFDM transceiver is used to send and receive MBOA transmissions. FIG. 8 shows that OFDM transceiver 804 includes a receiver portion 850 and a transmitter portion 860. Transmitter portion 860 includes an inverse fast fourier transform (IFFT) module 814, a zero padding module 816, an upconverter 818, and a transmit amplifier 820. IFFT module 814 receives frames for transmission from PHY controller 802. For each of these frames, IFFT module 814 generates an OFDM modulated signal. This generation involves performing one or more inverse fast fourier transform operations. As a result, this OFDM modulated signal includes one or more OFDM symbols. This signal is sent to zero padding module 816, which appends one or more “zero samples” to the beginning of each OFDM symbol to produce a padded modulated signal. Upconverter 818 receives this padded signal and employs carrier-based techniques to place it into one or more frequency bands. These one or more frequency bands are determined according to a frequency hopping pattern, such as one or more of the TFCs. As a result, upconverter 818 produces a frequency hopping signal, which is amplified by transmit amplifier 820 and transmitted through antenna 810.

FIG. 8 shows that receiver portion 850 includes a downconverter 822, a receive amplifier 824, and a fast fourier transform (FFT) module 826. These components (also referred to as a receiver) are employed in the reception of wireless signals from remote devices. In particular, antenna 810 receives wireless signals from remote devices that may employ frequency hopping patterns, such as one or more of the TFCs. These signals are sent to amplifier 824, which generates amplified signals. Amplifier 824 sends the amplified signals to downconverter 822. Upon receipt, downconverter 822 employs carrier-based techniques to convert these signals from its one or more frequency hopping bands (e.g.,TFC bands) into a predetermined lower frequency range. This results in modulated signals, which are received by FFT module 826, which performs OFDM demodulation on these signals. This demodulation involves performing a fast fourier transform for each symbol that is conveyed in the amplified signals.

As a result of this demodulation, FFT module 826 produces one or more frames, which are sent to PHY controller 802. These frames may convey information, such as payload data and protocol header(s). Upon receipt, PHY controller 802 processes these frames. This may involve removing certain PHY layer header fields, and passing the remaining portions of the frames to MAC controller 803.

As shown in FIG. 8, RFID reader module 806 is coupled to PHY controller 802. In addition, RFID reader module 806 is coupled to antenna 812. Module 806 includes components, such as amplifiers, a transmitter and a receiver, for the exchange of wireless RFID signals, such as amplitude shift keying (ASK) modulated signals.

As shown in FIG. 8, device 800 further includes one or more upper protocol layers 805. These layers may involve, for example, user applications. Accordingly, upper layers 805 may exchange information with remote devices. This involves layer(s) 805 exchanging protocol data units with MAC controller 803. In turn, MAC controller 803 operates with PHY controller 802 and transceiver 804 to transmit and receive corresponding wireless signals.

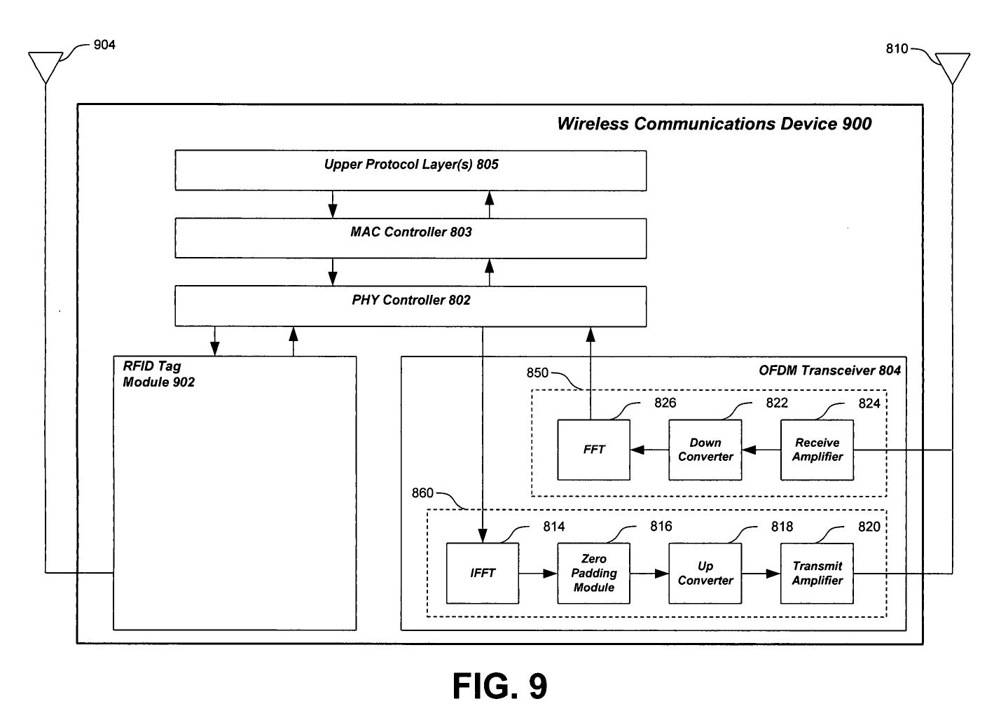

FIG. 9 is a block diagram of a wireless communications device 900 with MBOA and RFID tag capabilities. Device 900 is similar to device 800. For instance, device 900 includes physical layer (PHY) controller 802, media access controller (MAC) 803, OFDM transceiver 804, upper protocol layer(s) 805, and antenna 810. However, instead of including RFID reader module 806 and antenna 812, device 900 includes an RFID tag module 902 and an antenna 904. In embodiments of the present invention, device 900 may be used as a target device for non-MBOA communications within a portion of an MBOA transmission medium.

RFID tag module 902 includes components, such as a receiver and backscatter modulation circuitry for the receipt of RFID interrogation signals as well as the transmission of response signals.

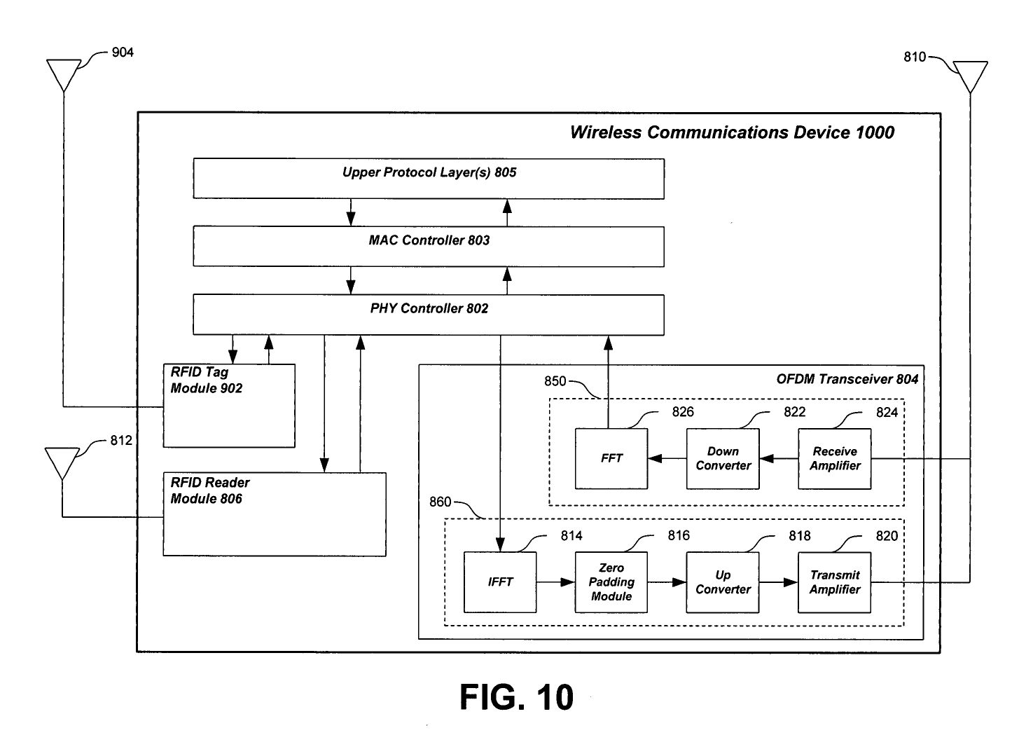

FIG. 10 is a block diagram of a wireless communications device 1000 with MBOA, RFID reader, and RFID tag capabilities. As shown in FIG. 10, device 1000 is similar to devices 800 and 900. In particular, device 1000 includes physical layer (PHY) controller 802, media access controller (MAC) 803, OFDM transceiver 804, upper protocol layer(s) 805, RFID reader module 806, RFID tag module 902, antenna 810, antenna 812, and antenna 904.

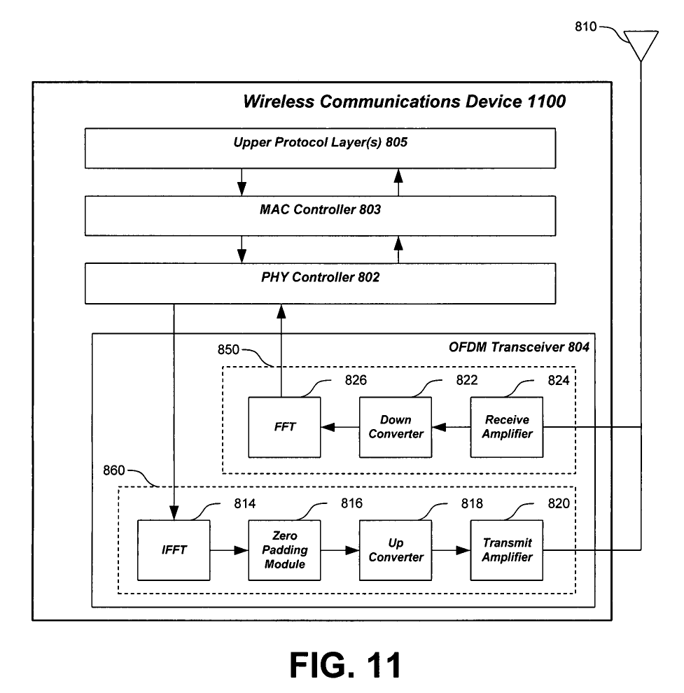

As described above, secondary transmissions may be OFDM signals. Accordingly, OFDM transceiver may be used for MBOA communications, as well as secondary transmissions, such as wake-up signaling. FIG. 11 is a block diagram of a device which may operate in this manner. As shown in FIG. 11, device 1100 includes physical layer (PHY) controller 802, media access controller (MAC) 803, OFDM transceiver 804, upper protocol layer(s) 805, and antenna 810.

As described above, when in a sleep state device 1100 (in the role of a target device) awaits a wake-up signal having a predetermined sequence of OFDM signals. Also, as indicated above, this wake up signal include further information to accelerate connection establishment. The predetermined sequence in the wake-up signal may be identified by PHY controller 802. Once this sequence is identified, device 1100 becomes activated and may join the already existing network.

The devices of FIGS. 8-11 may be implemented in hardware, software, firmware, or any combination thereof. For instance, within OFDM transceiver 804, upconverter 818, transmit amplifier 820, receive amplifier 824, and downconverter 822 may include electronics, such as amplifiers, mixers, and filters. Moreover, implementations of device 800 may include digital signal processor(s) (DSPs) to implement various modules, such as scanning module 806, IFFT module 814, zero padding module 816, and FFT module 826. Moreover, in embodiments of the present invention, processor(s), such as microprocessors, executing instructions (i.e., software) that are stored in memory (not shown) may be used to control the operation of various components in these devices. For instance, components, such as PHY controller 802 and MAC controller 803, may be primarily implemented through software operating on one or more processors.

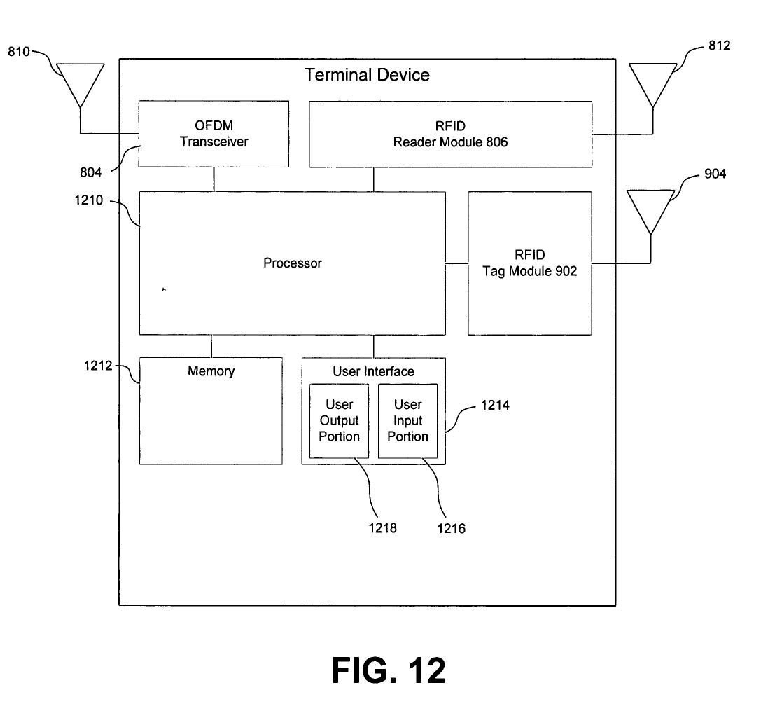

One such implementation of device 1000 is shown in FIG. 12. As shown in FIG. 12, this implementation includes a processor 1210, a memory 1212, and a user interface 1214. In addition, the implementation of FIG. 12 includes OFDM transceiver 804 and antenna 810. These components may be implemented as described above with reference to FIGS. 8-10. However, the implementation of FIG. 12 may be modified to include different transceivers that support other wireless technologies. Also, it is apparent that the features of FIG. 12 may be modified to implement devices 800, 900, and 1100.

Processor 1210 controls device operation. As shown in FIG. 12, processor 1210 is coupled to transceiver 804. Processor 1210 may be implemented with one or more microprocessors that are each capable of executing software instructions stored in memory 1212, for example, as a computer system.

Memory 1212 includes random access memory (RAM), read only memory (ROM), and/or flash memory, and stores information in the form of data and software components (also referred to herein as modules). These software components include instructions that can be executed by processor 1210. Various types of software components may be stored in memory 1212. For instance, memory 1212 may store software components that control the operation of transceiver 804. Also, memory 1212 may store software components that provide for the functionality of PHY controller 702, MAC controller 703, and upper protocol layer(s) 705.

In addition, memory 1212 may store software components that control the exchange of information through user interface 1214. As shown in FIG. 12, user interface 1214 is also coupled to processor 1210. User interface 1214 facilitates the exchange of information with a user. FIG. 12 shows that user interface 1214 includes a user input portion 1216 and a user output portion 1218.

User input portion 1216 may include one or more devices that allow a user to input information. Examples of such devices include keypads, touch screens, and microphones. User output portion 1218 allows a user to receive information from the device. Thus, user output portion 1218 may include various devices, such as a display, and one or more audio speakers (e.g., stereo speakers) and a audio processor and/or amplifier to drive the speakers. Exemplary displays include color liquid crystal displays (LCDs), and color video displays.

The elements shown in FIG. 12 may be coupled according to various techniques. One such technique involves coupling transceiver 804, processor 1210, memory 1212, and user interface 1214 through one or more bus interfaces. In addition, each of these components is coupled to a power source, such as a removable and/or rechargeable battery pack (not shown).

VII. Conclusion

While various embodiments of the present invention have been described above, it should be understood that they have been presented by way of example only, and not in limitation. For instance, although examples have been described involving MBOA communications, other short-range and longer-range communications technologies are within the scope of the present invention. Moreover, the techniques of the present invention may be used with signal transmission techniques other than OFDM.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
(a) participating in a wireless communications network, the wireless communications network having a transmission medium designated for exchanging wireless signals in a first format associated with the wireless communications network;
(b) reserving a portion of the transmission medium for the transmission of signals in a second format; and
(c) transmitting one or more signals of the second format to a remote wireless communications device, the one or more signals of the second format for facilitating a participation of the remote wireless communications in the wireless communications network.

2. The method of claim 1, wherein the second format is incompatible with the first format.

3. The method of claim 1, wherein the transmission medium includes a repeating time interval; and wherein step (b) comprises reserving one or more time slots within the repeating time interval.

4. The method of claim 1, wherein the wireless communications network is an MBOA network.

5. The method of claim 4, wherein step (b) comprises allocating one or more MBOA media access slots (MASs).

6. The method of claim 1, wherein step (c) comprises transmitting a wake-up signal to the remote device.

7. The method of claim 6, wherein the wake-up signal includes a predetermined sequence of OFDM symbols.

8. The method of claim 7, wherein the wake-up signal further includes an address of the remote device.

9. The method of claim 7, wherein the wake-up signal further includes configuration information regarding the wireless communications network.

10. The method of claim 7, further comprising:
(d) participating in the wireless communication network with the remote device.

11. The method of claim 1, wherein the remote device is in a hibernating state during receipt of the one or more signals in the second format.

12. The method of claim 1, wherein the remote device is in a sleep state during receipt of the one or more signals in the second format.

13. An apparatus, comprising:
a transceiver configured to exchange wireless signals in a first format associated with a wireless communications network participating in a wireless communications network
a processor; and
a memory, the memory storing instructions for the processor to direct the transceiver to reserve a portion of the transmission medium for the transmission of signals in a second format to a remote wireless communications device;
wherein the one or more signals of the second format facilitate a participation of the remote wireless communications in the wireless communications network.

14. The apparatus of claim 13, wherein the second format is incompatible with the first format.

15. The apparatus of claim 13, wherein the transmission medium includes a repeating time interval; and wherein the reserved portion of the transmission medium includes one or more time slots within the repeating time interval.

16. The apparatus of claim 13, wherein the wireless communications network is an MBOA network.

17. The apparatus of claim 16, wherein the reserved portion of the transmission medium includes one or more MBOA media access slots (MASs).

18. The apparatus of claim 16, wherein the one or more signals in the second format are radio frequency identification (RFID) signals.

19. The apparatus of claim 18, further comprising a second transceiver configured to exchange the one or more RFID signals with a remote device.

20. The apparatus of claim 13, wherein the memory further stores instructions for the processor to direct the transceiver to transmit a wake-up signal to the remote device.

21. The apparatus of claim 20, wherein the wake-up signal includes a predetermined sequence of OFDM symbols.

22. The apparatus of claim 21, wherein the wake-up signal further includes an address of the remote device.

23. The apparatus of claim 21, wherein the wake-up signal further includes configuration information regarding the wireless communications network.

24. An apparatus, comprising:
means for participating in a wireless communications network, the wireless communications network having a transmission medium designated for exchanging wireless signals in a first format associated with the wireless communications network;
means for reserving a portion of the transmission medium for the transmission of signals in a second format; and
means for transmitting one or more signals of the second format to a remote wireless communications device, the one or more signals of the second format for facilitating a participation of the remote wireless communications in the wireless communications network.

25. A computer program product comprising a computer useable medium having computer program logic recorded thereon for enabling a processor in a computer system to control a wireless communications device, the computer program logic comprising:
program code for enabling the wireless communications device to participate in a wireless communications network, the wireless communications network having a transmission medium designated for exchanging wireless signals in a first format associated with the wireless communications network;
program code for enabling the wireless communications device to reserve a portion of the transmission medium for the transmission of signals in a second format; and
program code for enabling the wireless communications device to transmit one or more signals of the second format to a remote wireless communications device, the one or more signals of the second format for facilitating a participation of the remote wireless communications in the wireless communications network.

26. A method, comprising:
(a) receiving one or more signals from a remote wireless communications device that participates in a wireless communications network, the wireless communications network having a transmission medium designated for exchanging wireless signals in a first format associated with the wireless communications network, wherein the one or more signals are within a portion of the transmission medium and in a second format that is incompatible with the wireless communications network; and
(b) in response to the one or more signals received from the remote wireless communications device, actively participating in the wireless communications network.

27. The method of claim 26, further comprising:
operating in a hibernating mode with respect to the wireless communications network during receipt of the one or more signals.

28. The method of claim 26, further comprising:
operating in a sleep mode with respect to the wireless communications network during receipt of the one or more signals.

29. The method of claim 26, wherein the wireless communications network is an MBOA network.

30. The method of claim 29, wherein the second format is a radio frequency identification (RFID) format.

31. An apparatus, comprising:
means for receiving one or more signals from a remote wireless communications device that participates in a wireless communications network, the wireless communications network having a transmission medium designated for exchanging wireless signals in a first format associated with the wireless communications network, wherein the one or more signals are within a portion of the transmission medium and in a second format that is incompatible with the wireless communications network; and
means for actively participating in the wireless communications network in response to the one or more signals received from the remote wireless communications device.

32. A computer program product comprising a computer useable medium having computer program logic recorded thereon for enabling a processor in a computer system to control a wireless communications device, the computer program logic comprising:
program code for enabling the wireless communications device to receive one or more signals from a remote wireless communications device that participates in a wireless communications network, the wireless communications network having a transmission medium designated for exchanging wireless signals in a first format associated with the wireless communications network, wherein the one or more signals are within a portion of the transmission medium and in a second format that is incompatible with the wireless communications network; and
program code for enabling the wireless communications device to actively participate in the wireless communications network in response to the one or more signals received from the remote wireless communications device.
